(19) United States
(12) Patent Application Publication
(10) Pub. No.: US 2018/0208827 A1
(43) Pub. Date: Jul. 26, 2018

(54) Internal Breaker for Water-Based Fluid and Fluid Loss Control Pill

(71) Applicant: M-I L.L.C., Houston, TX (US)

(72) Inventors: Pawilai Chinwangso, Humble, TX (US); Sooi Kim Lim, Aberdeen (GB); Hui Zhang, Sugar Land, TX (US)

(73) Assignee: M-I L.L.C., Houston, TX (US)

(21) Appl. No.: 15/541,462

(22) PCT Filed: Jan. 14, 2016
(86) PCT No.: PCT/US2016/013407

§ 371 Date: Jul. 3, 2017

Related U.S. Application Data
(60) Provisional application No. 62/104,393, filed on Jan. 16, 2015.

(51) Int. Cl. C09K 8/524

(52) U.S. Cl. CPC C09K 8/524; E21B 37/06; C09K 2208/18; C09K 2208/26

(57) ABSTRACT

A method comprising degrading a filtercake with a breaker comprising a urea-based polymer is provided. Also, a breaker composition is provided which includes a urea-based polymer that can hydrolyze in the presence of water and heat to release water-soluble byproducts and intermediates.

This application claims the benefit of U.S. Provisional Application No. 62/104,393 filed on Jan. 16, 2015, which is incorporated by reference herein in its entirety.

### BACKGROUND

During the drilling of a wellbore, various fluids are typically used in the well for a variety of functions. The fluids may be circulated through a drill pipe and drill bit into the wellbore, and then may subsequently flow upward through wellbore to the surface. During this circulation, the drilling fluid may act to remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the subterranean formation by providing sufficient hydrostatic pressure to prevent the ingress of formation fluids into the wellbore, to cool and lubricate the drill string and bit, and/or to maximize penetration rate.

Upon completion of drilling, a filter cake may develop on the surfaces of a wellbore from the accumulation of additives from a drilling fluid. This filter cake may stabilize the wellbore during subsequent completion operations such as placement of a gravel pack in the wellbore. Additionally, during completion operations, when fluid loss is suspected, a fluid loss pill of polymers and/or bridging agents may be spotted into the wellbore to reduce or prevent such fluid loss by injection of other completion fluids behind the fluid loss pill to a position within the wellbore which is immediately above a portion of the formation where fluid loss is suspected. Injection of fluids into the wellbore is then stopped, and fluid loss will then move the pill toward the fluid loss location. For example, a cross-linked hydroxyethyl cellulose (HEC) with sized calcium carbonate, rock salt or oil soluble resins can be used as a fluid loss control pill.

After any completion operations have been accomplished, removal of filter cake (formed during drilling and/or completion) remaining on the sidewalls of the wellbore may be necessary. Although filter cake formation and use of fluid loss pills are often used in drilling and completion operations, these barriers can present an impediment to the production of hydrocarbon or other fluids from the well, or to the injection of water and/or gas, if, for example, the rock formation is still plugged by the barrier. Because filter cake is compact, it often adheres strongly to the formation and may not be readily or completely flushed out of the formation by fluid action alone.

### DETAILED DESCRIPTION

In one embodiment, circulating a fluid into a wellbore may comprise spotting a fluid loss control pill (FLCP) to form a filtercake to inhibit fluid entry from the well into the formation. As used herein, a FLCP may also be considered a filtercake. In one embodiment, a method may include degrading a filtercake formed within a formation with a breaker comprising a urea-based polymer. As an example, the urea-based polymer of the breaker may comprise a hydrolyzable urea-aldehyde. The filtercake can be made up of urea-based polymer (e.g., urea-aldehyde condensation particles) that can be plastically deformable, hydrolyzable or a combination thereof, or sized urea-aldehyde particles as bridging materials. In another embodiment, the urea-aldehyde may act as internal breaker to further break down biopolymers in fluid and a filtercake to reduce formation damage without the need to use an external breaker. In an embodiment, the urea-aldehyde particles of the filtercake may be hydrolyzed at a higher rate by an accelerator which includes a polyester.

In embodiments, the FLCP and/or filtercake can degrade by the use of urea-based breaker, such as a urea-aldehyde polymer, into the wellbore. In some embodiments, the urea-aldehyde can hydrolyze in the presence of water and heat to release water-soluble byproducts and intermediates, i.e., urea, aldehyde, and carboxylic acid end groups. In an embodiment where the polymer is used in the pill, the byproducts can break the polymer to enhance cleanup of the fluid and filtercake. In another embodiment, the polyester, such as polyglycolic acid (PGA), polylactic acid (PLA), or other slowly hydrolysable polyester that forms acid and lowers the pH at formation conditions may be used in a combination with urea-based polymer, such as urea-aldehyde, to accelerate the degradation and breakdown of the filtercake, and vice versa. Depending on downhole conditions, the suitable combination of urea-aldehyde and polyester may be used to provide variable degradation rate of the filtercake and adequate stability at related temperatures.

In embodiments, the urea-aldehyde polymer of the breaker can be selected from urea, urea-formaldehyde, urea-isobutyraldehyde, urea-crotonaldehyde, polyurea, poly(urea-formaldehyde), poly(urea-isobutyraldehyde), poly(urea-crotonaldehyde), urea-isobutyraldehyde-formaldehyde, copolymers of urea with other aldehydes, and mixtures thereof.

In other aspects, the breaker composition may comprise a hydrolyzable polyester. In embodiments, the polyester can be selected from the group consisting of lactide, glycolide, polylactic acid, polyglycolic acid, copolymers of polylactic acid and polyglycolic acid, copolymers of glycolic acid with other hydroxy-, carboxylic acid-, or hydroxycarboxylic acid-containing moieties, copolymers of lactic acid with other hydroxy-, carboxylic acid-, or hydroxycarboxylic acid-containing moieties, and mixtures thereof.

In an embodiment, the FLCP comprises particles having a mean diameter greater than 5 microns. In an embodiment, the FLCP comprises particles having a plurality of size gradings. Alternatively or additionally, the FLCP can comprise particles having a plurality of shape types selected from beads, powders, spheres, ribbons, platelets, fibers, flakes, and so on, and combinations thereof.

The method in one embodiment is applied to a formation that is suitable for gravel packing, such as unconsolidated sand, for example, a formation having a compressive strength less than about 6.9 MPa (1000 psi). In an embodiment, the formation has a permeability greater than about 10 mD, or greater than about 50 mD.

In embodiments, the completion operation can include cleanout, gravel packing, or the like, or a combination thereof. In an embodiment, the filtercake can plug a perforation tunnel, e.g., in a cased-hole completion, until cleanout. Because the urea-aldehyde particles can degrade spontaneously after a certain period of time at the downhole conditions, the method can effectively remove the filtercake from the perforations to facilitate proper gravel placement in the perforation tunnels.

In an embodiment, the urea-aldehyde bridging agent can decompose spontaneously at the downhole temperature and aqueous environment into soluble hydrolysis products, facilitating filtercake removal even without a distinct flushing step. In an embodiment, the method can include backflow flushing of filtercake residue wherein flushing fluid consists essentially of reservoir fluid produced in situ from the formation after the filtercake is formed. In another embodiment, reservoir fluid can be produced directly from the formation without intermediate recirculation of a flushing fluid in the well to remove filtercake residue.

FLCPs may be used in some embodiments to control leak-off of completion brine after perforating and before gravel packing or frac-packing. They are also used in an additional or alternate embodiment to isolate the completion and wellbore fluid after gravel packing by spotting the pill inside the screen. FLCPs, in an embodiment, can contain a urea-aldehyde bridging agent, optionally with or without a hydrolysis accelerator, such as the polyester.

The bridging agents in embodiments are particles sized such that they block the openings in the screen, or the pores of the formation. In an embodiment, the urea-aldehyde can hydrolyze in the presence of water and heat occurring at downhole conditions to release water-soluble hydrolysis products, i.e., urea and aldehyde, and other intermediate byproducts that may contain carboxylic acid end groups. In an embodiment where the polymer used in the pill, the acid can break the polymer. Because the acid can be generated locally in all the perforations in an embodiment, a uniform removal of filtercake can be achieved. In an embodiment, a separate or additional treatment step is not required for removal of filtercake because the cake may be self-destructive. In an embodiment, the particles can be essentially inert at surface conditions and easily added to the completion brine or any polymer system. Thus, an extensive quality control program is not required to mix the pill on location.

The above mentioned degradable materials in some embodiments are comprised solely of urea-aldehyde condensate particles. Other embodiments, the degradable materials are comprised of urea-aldehyde particles and polyester particles. Different form of degradable materials may be used, for example, beads, powders, spheres, ribbons, platelets, fibers, flakes, and so on, and combinations thereof.

Examples of degradable urea-aldehyde condensates that may be used in embodiments of the FLCP can include, but not limited to, urea, urea-formaldehyde, urea-isobutyraldehyde, urea-crotonaldehyde, polyurea, poly(urea-formaldehyde), poly(urea-isobutyraldehyde), poly(urea-crotonaldehyde), urea-isobutyraldehyde-formaldehyde, copolymers of urea with other aldehydes, and mixtures thereof.

Examples of polyester materials that may be used herein are not limited to lactide, glycolide, polylactic acid, polyglycolic acid, a copolymer of polylactic acid and polyglycolic acid, a copolymer of glycolic acid with other hydroxyl-, carboxylic acid-, or hydroxycarboxylic acid-containing moieties, a copolymer of lactic acid with other hydroxy-, carboxylic acid or hydroxycarboxylic acid-containing moieties, or mixtures of the preceding. Specific examples include homopolymers, random, block, graft, and star- and hyper-branched aliphatic polyesters. Polyesters can be prepared by, for example, polycondensation reactions, ring-opening polymerizations, free radical polymerizations, coordinative ring-opening polymerizations, and any other suitable process. Specific examples of suitable polymers include aliphatic polyesters; poly(lactides); poly(glycolides); poly(ε-caprolactones); poly(hydroxybutyrates); poly(anhydrides); aliphatic polycarbonates; poly(orthoesters); poly(amino acids); polyphosphazenes, and the like.

In an embodiment the urea-aldehyde material may degrade after temporarily sealing for fluid loss during the treatment operation, and helps restore permeability and conductivity for reservoir fluid production. The degradation of urea-aldehyde generally includes hydrolysis of the urea-aldehyde moieties at downhole conditions of elevated temperature and an aqueous environment into hydrolysis products such as urea, aldehyde moieties, carboxylic acid and hydroxyl intermediates, for example. The hydrolysis in one embodiment can render the urea-aldehyde filtercake degradation products entirely soluble in the downhole and/or reservoir fluids. In an alternative or additional embodiment, the entire filtercake need not be entirely soluble following urea-aldehyde degradation; it is sufficient only that enough hydrolysis occurs so as to allow the residue of the degraded or partially degraded filter cake to be lifted off of the sealed surface by a low backflow pressure from produced reservoir fluids.

The above mentioned degradable materials in one embodiment are comprised solely of urea-aldehyde particles. In another embodiment, the polyester can be mixed or blended with the urea-aldehyde for the purpose of increasing the rate of dissolution and hydrolysis of the degradable urea-aldehyde materials.

In some aspects, the FLCP comprises a brine carrier having a density of at least 1.02 kg/L (8.5 ppg (8.5 pounds per gallon)), but may be as low as 1 kg/L (8.3 ppg). As used herein, a heavy brine, sometimes also called a high density brine or high brine, is an aqueous inorganic salt solution having a specific gravity of greater than about 1.02 kg/L (8.5 lb/gal (ppg)), 1.08 kg/L (9 ppg) or 1.14 kg/L (9.5 ppg), especially above 1.2, 1.32, 1.44 or 1.5 kg/L (10, 11, 12 or 12.5 ppg), or up to 1.8 kg/L (15 ppg). Available water, other than brine, may also be used in some embodiments as the carrier for the FLCP.

When used, the brine is water comprising an inorganic salt or organic salt. Embodiments of inorganic monovalent salts include alkali metal halides, more preferably sodium, potassium or cesium bromide. Embodiments of inorganic divalent salts include calcium halides, for example, calcium chloride or calcium bromide. Zinc halides, especially zinc bromide, may also be used. Inorganic salt can be added to the carrier fluid in any hydration state (e.g., anhydrous, monohydrated, dihydrated, etc.). The carrier brine phase may also comprise an organic salt, in embodiments sodium or potassium formate, acetate or the like, which may be added to the treatment fluid up to a concentration at which phase separation might occur, approximately 1.14 kg/L (9.5 ppg). In an embodiment, mixture of organic and inorganic salts can achieve a density higher than about 1.2 kg/L (10 ppg). The salt in one embodiment of the FLCP is compatible with the drilling fluid which was used to drill the wellbore, or in a completion/clean up fluid, e.g., the salt in the FLCP can be the same as the salt used in the drilling fluid and/or other completion fluids.

The FLCP can be prepared with or without a thickening agent such as a polymer. In an embodiment, the degradable urea-aldehyde particles can have a specific gravity that is similar to an aqueous carrier fluid such as fresh water or brine so that a high viscosity or other rheological modifications are not necessary to maintain dispersion of the bridging agent in the carrier fluid. Thus, where a polymer-free filtercake is desired the FLCP can be essentially free of polymer, i.e., slickwater. If a polymer is used to generate viscosity in the FLCP, only a minimal fluid viscosity can be sufficient to prevent undue settling of the bridging agent during preparation and placement of the pill within the wellbore. Since the present disclosure can allow better sealing by the bridging agent in the filtercake, a lower concentration of polymer can be utilized to facilitate a primary goal of avoiding formation damage.

Embodiments of polymer concentrations, when present, can vary with temperature, fluid system, formation depth and bridging agent properties and loading, screen size, permeability, gravel size, and the like, but non-limiting exemplary ranges can include 0.12 to 9.6 g/L (1 to 80 lb of polymer per 1000 gallons), or 1.2 to 4.8 g/L (10 to 40 lb of polymer per 1000 gallons). In embodiments, polymers may include galactomannans such as guar, derivatized guars such as hydroxypropyl guar, carboxymethyl guar, carboxymethylhydroxypropyl guar, hydrophobically modified galactomannans, xanthan gum, hydroxyethyl cellulose, and polymers, copolymers and terpolymers containing acrylamide monomer, and the like.

Some non-limiting examples of suitable polymers include: polysaccharides, such as, for example, guar gums, high-molecular weight polysaccharides composed of mannose and galactose sugars, including guar derivatives such as hydroxypropyl guar (HPG), carboxymethyl guar (CMG), and carboxymethylhydroxypropyl guar (CMHPG), and other polysaccharides such as xanthan, diutan, and scleroglucan; cellulose derivatives such as hydroxyethyl cellulose (HEC), hydroxypropyl cellulose (HPC), carboxymethylhydroxypropyl cellulose (CMHEC), and the like; synthetic polymers such as, but not limited to, acrylic and methacrylic acid, ester and amide polymers and copolymers, polyalkylene oxides such as polymers and copolymers of ethylene glycol, propylene glycol or oxide, and the like. The polymers are preferably water soluble. Also, associative polymers for which viscosity properties are enhanced by suitable surfactants and hydrophobically modified polymers can be used, such as cases where a charged polymer in the presence of a surfactant having a charge that is opposite to that of the charged polymer, the surfactant being capable of forming an ion-pair association with the polymer resulting in a hydrophobically modified polymer having a plurality of hydrophobic groups.

As used herein, when a polymer is referred to as comprising a monomer or comonomer, the monomer is present in the polymer in the polymerized form of the monomer or in the derivative form of the monomer. However, for ease of reference the phrase comprising the (respective) monomer or the like may be used as shorthand.

The polymers may optionally be cross-linked with polyvalent cations such as borate or metal ions, for example, zirconium or titanium including complexed metals, and so on. While linear (non-cross-linked) polymer systems can be used in an embodiment, they generally require higher polymer levels for the same rheological modification. In some embodiments, the fluids used may further include a cross-linker. Adding cross-linkers to the fluid may further augment the viscosity of the fluid. Cross-linking consists of the attachment of two polymeric chains through the chemical association of such chains to a common element or chemical group.

The present disclosure also provides a method in completion operations where, after the treatment and fluid loss control is no longer needed or desirable, a high breaker loading is provided within the filtercake where any polymer viscosifier is concentrated. In effect, the urea-aldehyde bridging agent hydrolyzes in an embodiment to soluble hydrolysis products such as acid intermediate and thus becomes the breaker. In an embodiment, a single additive can serve as both the bridging agent and breaker, i.e. as the only bridging agent and as the only breaker. When activated after an appropriate delay to allow the relevant completion operations to be completed, the breaker reduces the viscosity and yield stress where the filter cake residue dissolves and mixes with reservoir fluids, and can thus lead to enhanced cleanup. Additional breaker, such as polyester, can optionally be added in an embodiment to increase the hydrolysis rate of the urea-aldehyde breaker and assist or facilitate breaking of the viscosifier for FLCP clean up.

In embodiments, the urea-aldehyde bridging agent can have a particle size distribution to effectively seal the gravel packing screen, perforation tunnels and/or formation as needed to be an effective temporary fluid loss control for the formation. In embodiments, the bridging particulates have a size less than 100 mesh (150 microns), between 150 and 325 mesh (about 40 to 100 microns), or less than 325 mesh (about 40 microns). In general, larger particle sizes are used to treat screens, very high permeability formations and formations with natural fissures, whereas smaller sizes are used with lower permeability formations. In one embodiment, a mixture of particles of different sizes, for example a bimodal distribution, can be used.

The particles in the FLCP may be used in conjunction with other materials that aid in controlling fluid loss, such as silica flour, mica, or polymers such as starch or guars, provided either that the additional material is at least partially degraded after closure, or is present in a sufficiently small amount that it does not seriously detract from the efficacy of the treatment. The filtercake need not be entirely broken; it is sufficient only that enough breaking occurs so as to allow the filter cake residue to be lifted off of the sealed surface by a low backflow pressure from produced reservoir fluids. In an embodiment, complete or essentially complete elimination of flow impairment from the formation through the temporarily sealed surface is achieved.

Embodiments of the present disclosure may use other additives and chemicals that are known to be commonly used in oilfield applications by those skilled in the art. These include, but are not necessarily limited to, materials in addition to those mentioned hereinabove, such as breaker aids, oxygen scavengers, alcohols, antifoaming agents, pH buffers, scale inhibitors, corrosion inhibitors, fluid-loss additives, bactericides, iron control agents, organic solvents, water control agents and cleanup additives, gas components, and the like, depending on the intended use of the fluid, formation conditions and other parameters readily apparent to one of ordinary skill in the art. For example, drilling fluids may further comprise surface active agents, other viscosifiers such as polymers, filtration control agents such as Gilsonite and modified starches, density increasing agents such as powdered barites or hematite or calcium carbonate, or other wellbore fluid additives known to those skilled in the art.

In embodiments, the FLCP is used to seal the formation face in the completion zone. The method is applicable to open hole or cased completion zones, for example. Open hole completions in an embodiment include underreamed zones wherein the producing formation is underreamed to enhance productivity. The FLCP described herein may be positioned in the wellbore to contact the formation face and overbalanced to force the liquid carrier into the formation and form a filtercake by screening the bridging agent particles at the entrances to the pores or other passages opening at the formation surface.

The filtercake formed, in one embodiment, does not substantially degrade until the completion operations are finished and it is desired to produce the well. The well should be kept at least slightly overbalanced in one embodiment to keep the filtercake from being prematurely lifted off a screen. In embodiments, the well can be shut in for a period of time for the urea-aldehyde bridging agent particles, either with our without polyester, to degrade and/or dissolve, or can be placed in production for the backflow of reservoir fluid to facilitate flushing of any filtercake residue from the screen.

### EXAMPLES

The following examples are provided to demonstrate various approaches to preparing and using catalytic systems in accordance with the present disclosure. An example urea-aldehyde used herein is MagDivert 2000, which is commercially available from Magnablend Inc. (Waxahachie, Tex.).

### Example 1

50 ppb of urea-formaldehyde was added to polymer fluid containing xanthan gum and starch. Different sizes of urea-formaldehyde were added to be used as a sold bridging material on the aloxite disc, as shown in Table 1. The fluid loss control and cleanup tests were performed at 250° F., as well as static aging test to observe fluid stability over time. Rheological properties of the fluids with 0.5 ppb, 1.0 ppb, and 2.0 ppb loadings of viscosifier were monitored, as shown in Table 2. Higher loading of xanthan gum increased fluid viscosity. The drop in rheology after static aging at 250° F. for one day showed a sign of fluid degradation. With a combination of heat and water, the urea-formaldehyde can undergo hydrolysis and release water-soluble byproducts to the fluid environment. These byproducts react with other biopolymer components in the system, i.e., starch and xanthan, and cause them to subsequently undergo degradation. This proves that urea-formaldehyde can be used as an effective breaker to break water-based FLCP without having to add any conventional external breaker.

TABLE 1
Formulation of NaBr-based FLCP used in this study

| Component | Concentration (lbs/bbl) |
|---|---|
| 9.98 ppg NaBr brine | 0.81 bbl |
| pH buffer | 0.50 |
| Viscosifier | 0.5-2.0 |
| Fluid loss additive | 7.00 |
| Bridging/internal breaker | 36.00 |
| (urea-formaldehyde - 50 | |
| microns) | |
| Bridging/internal breaker | 14.00 |
| (urea-formaldehyde - 150 | |
| microns) | |

TABLE 2
Rheological properties of NaBr-based FLCP, the formulation of
which is shown in Table 1; after yielding overnight at ambient,
1 day, and 2 days static aging at 250° F., with different
loadings of viscosifier; 0.5, 1, and 2 ppb.

| Properties | | 0.5 ppb | 1 ppb | 2 ppb |
|---|---|---|---|---|
| | | After yielding overnight at ambient | | |
| | | conditions | | |
| pH | | 8.2 | 8.98 | 8.29 |
| Rheology at 120° F. | 600 rpm | 158 | 221 | >300 |
| | 300 rpm | 125 | 192 | >300 |
| | 200 rpm | 104 | 166 | 278 |
| | 100 rpm | 85 | 41 | 237 |
| | 6 rpm | 46 | 79 | 130 |
| | 3 rpm | 44 | 73 | 116 |
| PV | cP | 33 | 29 | — |
| YP | lb/100 ft² | 92 | 163 | — |
| | | After static aging at | | |
| | | 250° F. for 1 day | | |
| pH | | 8.78 | 8.92 | 9.02 |
| Rheology at | 600 rpm | 21 | 157 | 190 |
| ambient | | | | |
| | 300 rpm | 13.8 | 115 | 148 |
| | 200 rpm | 11 | 101 | 125 |
| | 100 rpm | 7.6 | 84 | 106 |
| | 6 rpm | 2 | 40 | 60 |
| | 3 rpm | 1.6 | 36 | 55 |
| PV | cP | 7.2 | 42 | 42 |
| YP | lb/100 ft2 | 6.6 | 73 | 106 |
| | | After static aging at | | |
| | | 250° F. for 2 days | | |
| pH | | 8.98 | 9.04 | 9.03 |
| Rheology at | 600 rpm | 17.6 | 39 | 69 |
| ambient | | | | |
| | 300 rpm | 11.4 | 28 | 54 |
| | 200 rpm | 9.2 | 24 | 45 |
| | 100 rpm | 6.2 | 18 | 36 |
| | 6 rpm | 1.8 | 7 | 13 |
| | 3 rpm | 1.4 | 5 | 10 |
| PV | cP | 6.2 | 11 | 15 |
| YP | lb/100 ft2 | 5.2 | 17 | 39 |

Fluid loss tests were performed at 250° F. with differential pressure of 500 psi and showed that urea-formaldehyde, with a combination of bridging package, can be used as an effective bridging material. Without other typical bridging solids, for example, sized calcium carbonate, sized urea-formaldehyde can provide fluid loss control for up to 24 hours at 250° F. test condition, as shown in Table 3. The cleanup efficiency after 7 days soak of 62% and 94% production can be achieved with 1 ppb and 0.5 ppb viscosifier loadings, respectively. These confirm the static aging data that urea-formaldehyde is an effective internal breaker which can be incorporated into fluid directly. Not only does it function as a practical bridging material, but it also functions as effective breaker to enhance self-cleanup of the FLCP.

TABLE 3
Fluid loss data at 250° F., 500 psi of each FLCP with
different viscosifier loadings using 5-micron aloxite discs

| | Fluid Loss (mL) | | |
|---|---|---|---|
| Time | 0.5 ppb | 1 ppb | 2 ppb |
| Spurt | 3 | 0.5 | 0.5 |
| 3 min | 2 | 1.5 | 1.5 |
| 10 min | 3.5 | 3.5 | 3.5 |
| 30 min | 6.2 | 6.5 | 5.75 |
| 1 hour | 9.5 | 9.5 | 9.5 |
| 5 hours | 26 | 25.5 | 27 |
| 23 hours | 38.5 | 39.5 | 48.5 |
| 24 hours | 41.7 | 41 | Breakthrough |

### Example 2

The cross-linked HEC, for example SAFE-LINK, which is commercially available from MI-SWACO (Houston, Tex.), was tested with one type of degradable polymer as an internal breaker, either urea-formaldehyde or polylactic acid (PLA). The HTHP fluid loss test at 220° F. from Table 4 showed that even with lower loading of PLA (5 ppb) as compared to urea-formaldehyde (7 ppb), the cross-linked HEC fluid loss control pill showed sign of breakthrough, i.e., filtercake degradation, within 24 hours. The filter cake from the urea-formaldehyde pill was able to hold up and showed stability for at least 7 days. However, with urea-formaldehyde alone, the higher stability of the pill interferes with cleanup efficiency as the filter cake remained intact and failed the flowback tests after 9 days, the same as that of baseline without an internal breaker within the pill.

TABLE 4
Fluid loss data at 220° F., 200 psi of cross-linked
HEC FLCP with different degradable materials:

| | #1, ppb | #2, ppb |
|---|---|---|
| Component | | |
| Brine base fluid | 144 | 144 |
| Water base fluid | 114 | 114 |
| urea-formaldehyde | 7 | 0 |
| internal breaker | | |
| PLA internal | 0 | 5 |
| breaker | | |
| Cross-linked fluid | 180 | 180 |
| loss additive | | |

Fluid Loss (mL)

| | | |
|---|---|---|
| Time | | |
| Spurt | 8 | 22 |
| 30 min | 5 | 14 |
| 45 min | — | 16 |
| 68 h | — | Breakthrough |
| | | between 100 min |
| | | and 68 h |
| 120 h | 109 | — |
| 210 h | 123 | — |

### Example 3

The combination of urea-formaldehyde and polyester was used as an internal breaker package to investigate a combined performance between both materials. From Example 2, it appears that PLA degrades the cross-linked HEC fluid relatively quickly while urea-formaldehyde, on the other hand, degrades the HEC at a slower rate at 220° F. The formulations with different concentration of urea-formaldehyde/PLA were formulated, as shown in Table 5. With first combination of higher loading of PLA and lower loading of urea-formaldehyde (Formulation #3), the cross-linked HEC fluid loss pill showed sign of breakthrough roughly after 4-5 days at HTHP conditions. The latter two, on the other hand, were stable and provided fluid stability at least 7 days. However, Formulation #4 provided better cleanup where it only took 72 seconds to flowback 200-mL of oil as compared to 124 seconds achieved from Formulation #5. Therefore, the required time for the filter cake stability and its ability to flowback can be controlled by the different combination of urea-formaldehyde and PLA as an internal breaker combination.

TABLE 5
Fluid loss data at 220° F., 200 psi of each
cross-linked HEC FLCP with different concentration
of each degradable material

| Components | #3, ppb | #4, ppb | #5, ppb |
|---|---|---|---|
| 12.5 ppg NaBr brine | 144 | 144 | 144 |
| Water base fluid | 114 | 114 | 114 |
| urea-aldehyde | 3.5 | 5 | 6 |
| internal breaker | | | |
| PLA breaker | 3.5 | 2 | 1 |
| accelerator | | | |
| Cross-linked HEC | 180 | 180 | 180 |
| fluid loss additive | | | |
| Time | Fluid Loss (mL) | | |
| Spurt | 23 | 20 | 18 |
| 30 min | — | 17 | 24 |
| 1 h | 37 | 23 | 32 |
| 24 h | — | 85 | 122 |
| 48 h | — | 102 | 139 |
| 70 h | 100 | 110 | 147 |
| 120 h | Breakthrough | — | — |
| 130 h | | 132 | 160 |
| 153 h | | 136 | 171 |
| 189 h | | 140 | 173 |
| 210 h | | 143 | 178 |
| | Flowback Test | | |
| Pressure | Time to collect 200 mL of Base oil | | |
| 10 psi | 17.25 sec | — | — |
| 15 psi | — | 330 sec | 361 sec |
| 20 psi | — | 72 sec | 124 sec |

### Example 4

Example 3 shows that the polyester can be used as an accelerator to increase the breakdown rate of the cross-linked HEC pill in the presence of urea-formaldehyde. Conversely, the urea-formaldehyde can be used as the polyester hydrolysis inhibitor. From Table 6, the tests were performed to compare the performance of the cross-linked HEC fluid loss pill between using PLA alone (2.5 ppb) and PLA with urea-formaldehyde (2.5 ppb and 4.5 ppb, respectively). The filtercake showed breakthrough in 21 hours for the former case, while the latter took place roughly after 2-3 days. By using a combination of both products, one can balance the performance of another and offers improvement between fluid/filter cake stability and cleanup for the whole system.

TABLE 6
Fluid loss data at 220° F., 200-500 psi of cross-linked
HEC FLCP with different degradable materials

| | #6, ppb | #7, ppb |
|---|---|---|
| Components | | |
| 12.5 ppg NaBr brine | 144 | 144 |
| Water base fluid | 114 | 114 |
| urea-aldehyde internal breaker | 4.5 | 0 |
| PLA internal breaker | 2.5 | 2.5 |
| Cross-linked HEC fluid loss | 180 | 180 |
| additive | | |
| Time | | |
| Spurt | 90 | 100 |
| 30 min | 117 | 130 |
| 1 h | 118 | 132 |
| 4 h | — | 136 |
| 21 h | 135 | Breakthrough |
| 24 h | 138 | |
| 72 h | Breakthrough | |
| | between 48 | |
| | and 72 h | |

Although the preceding description has been described herein with reference to particular means, materials, and embodiments, it is not intended to be limited to the particulars disclosed herein; rather, it extends to all functionally equivalent structures, methods and uses, such as are within the scope of the appended claims.

What is claimed:

1. A method comprising:
degrading a filtercake formed within a formation with a breaker comprising a urea-based polymer.

2. The method of claim 1, wherein the urea-based polymer is a hydrolyzable urea-aldehyde.

3. The method of claim 1, wherein the urea-based polymer is selected from a urea, a urea-formaldehyde, a urea-isobutyraldehyde, a urea-crotonaldehyde, a polyurea, a urea-formaldehyde, a poly(urea-isobutyraldehyde), a poly(urea-crotonaldehyde), a urea-isobutyraldehyde-formaldehyde, copolymers of urea with other aldehydes, and a mixture thereof.

4. The method of claim 1, wherein the filtercake comprises a urea-based polymer.

5. The method of claim 4, wherein the urea-based polymer is a urea-aldehyde.

6. The method of claim 4, wherein degrading the filtercake comprises hydrolyzing the urea-based polymer of the filtercake.

7. The method of claim 1, wherein the filtercake comprises sized urea-aldehyde particles as bridging materials.

8. The method of claim 1, wherein the breaker further comprises a hydrolyzable polyester.

9. The method of claim 8, wherein the hydrolyzable polyester is selected from a lactide, a glycolide, a polylactic acid (PLA), a polyglycolic acid (PGA), a copolymer of PLA and PGA, a copolymer of glycolic acid with other hydroxy-, carboxylic acid-, or hydroxycarboxylic acid-containing moieties, a copolymer of lactic acid with other hydroxy-, carboxylic acid, or hydroxycarboxylic acid-containing moieties, and a mixture thereof.

10. A breaker composition comprising:
a urea-based polymer.

11. The composition of claim 10, wherein the urea-based polymer is a urea-aldehyde.

12. The composition of claim 11, wherein the urea-aldehyde-based polymer is selected from a urea, a urea-formaldehyde, a urea-isobutyraldehyde, a urea-crotonaldehyde, a polyurea, a urea-formaldehyde, a poly(urea-isobutyraldehyde), a poly(urea-crotonaldehyde), a urea-isobutyraldehyde-formaldehyde, copolymers of urea with other aldehydes, and a mixture thereof.

13. The composition of claim 10 further comprising:
a hydrolyzable polyester.

14. The composition of claim 13, wherein the polyester is selected from a lactide, a glycolide, a polylactic acid, a polyglycolic acid, a copolymer of polylactic acid and polyglycolic acid, a copolymer of glycolic acid with other hydroxy-, carboxylic acid-, or hydroxycarboxylic acid-containing moieties, a copolymer of lactic acid with other hydroxy-, carboxylic acid, or hydroxycarboxylic acid-containing moieties, and a mixture thereof.
